(19) United States
(12) Patent Application Publication
(10) Pub. No.: US 2015/0032814 A1
(43) Pub. Date: Jan. 29, 2015

(54) SELECTING AND SERVING CONTENT TO USERS FROM SEVERAL SOURCES

(71) Applicant: Rabt App Limited, Ballsbridge (IE)

(72) Inventors: Ioannis Broustas, Long Island City, NY (US); Georgios Lentzas, New York, NY (US)

(21) Appl. No.: 14/337,696

(22) Filed: Jul. 22, 2014

Related U.S. Application Data
(60) Provisional application No. 61/857,344, filed on Jul. 23, 2013.

(51) Int. Cl. H04L 29/06

(52) U.S. Cl. CPC H04L 67/42
USPC 709/204

(57) ABSTRACT

Systems and methods for evaluating and retrieving content from several sources and intelligently selecting and serving the content to an end user may include an initial seeding process to determine initial preferences for the end user for generating a customized sequence of content to be presented to the user. As the end user consumes the content, the end user can provide response feedback indicative of the end user's preference for and/or relevance of the presented content. As content is presented to the end user, the feedback may be used to select and serve subsequent content to present to the end user by updating the customized sequence of content.

### CROSS-REFERENCE TO RELATED PATENT APPLICATIONS

This application claims priority from U.S. Provisional Pat. Appln. No. 61/857,344, filed Jul. 23, 2013, and entitled “Method and Apparatus for Collecting Content from Multiple Sources and Serving Content to End Users” the disclosure of which is hereby incorporated by reference.

### BACKGROUND

End users experience content through a variety of devices and sources. For instance, some end users using client devices, such as mobile devices, laptops, desktops, etc., may retrieve and serve content from a website as a media aggregation website, a social networking website, etc. In other instances, end users may utilize an application for retrieval and serve content, such as a music application, a video application, a social media application, etc. However, existing solutions may be limited for a variety of reasons. For instance, some existing solutions may invest in obtaining the best content providers to generate content, but may not be capable of controlling the amount of extraneous content that is generated or added that may be irrelevant or unwanted. This clutter may make it difficult for end users to find content in which they are interested. In other instances, some existing solutions permit a plethora of content to be added to generate a pool of available content. Such a solution may be focused on reaching users via a pull model (i.e., end users have to go and select which content they want to watch), but end users may become lost in the vast pool of available content. In some instances, existing solutions may analyze historical data to determine content in which the end user may be interested, such as data from social media activity, data regarding previously visited web pages etc. However, such historical data may be outdated and/or may not reflect contemporaneous user feedback regarding how the end user feels about recently served content and/or how relevant the recently served content was. In some instances, the existing solutions may also be limited in monetizing the traffic the available content generates. For instance, for a content provider that utilizes a pull model for a website offering content, the website may be limited to providing banner-type advertisements and may not be capable of providing rich media advertisements, video advertisements, and/or other interactive advertisements.

### SUMMARY

Implementations described herein relate to systems and methods for evaluating and retrieving content from several sources and intelligently selecting and serving the content to an end user. The selection and serving of the content to the end user may utilize an initial seeding process to determine initial preferences for the end user for generating a customized sequence of content to be presented to the user. As the end user consumes the content, the end user can provide feedback indicative of the end user's preference for the content and/or the relevance of the content to the end user. Feedback can generally be understood as an indicator of a positive or negative response of a user to an item of content. In some implementations, the feedback may be direct feedback, such as a selection of a positive feedback selection feature or negative feedback selection feature. In other implementations, the feedback may be indirect feedback, such as monitoring actions or inaction of an end user to an item of content. As additional content is served to the user, the corpus of feedback and previously served content may be used to update and/or modify the determined initial preferences such that future selected and served content may more accurately reflect the contemporaneous preferences of the end user.

One implementation relates to a method of serving content to an end user of a client device. The method may include determining preference data for an end user responsive to feedback received from the end user. The method may also include calculating a content appeal score for each of several of items of content based, at least in part, on the preference data. The method may further include generating a customized sequence of content for the end user based, at least in part, on the calculated content appeal scores for each of several of items of content. The method may still further include serving the generated customized sequence of content to a client device of the end user responsive to a request from the client device.

Another implementation relates to a system that includes one or more data processors and a non-transitory computer-readable storage device storing instructions that, when executed by the one or more data processors, cause the one or more data processors to perform several operations. The operations may include receiving a generated customized sequence of content responsive to a request and presenting a first item of content of the generated customized sequence of content. The operations may also include preventing presentation of a second item of content of the generated customized sequence of content until a feedback response is received. The operations further include receiving the feedback response responsive to the presented first item of content and transmitting the received feedback to a customized content sequence generation system.

A further implementation relates to a non-transitory computer-readable storage device storing instructions that, when executed by one or more data processors, cause the one or more data processors to perform several operations. The operations may include receiving an interactive initial seeding sequence including a pair of items of seeding content and presenting the pair of items of seeding content via a seeding interface. The operations may also include receiving a selection of one of the presented pair of items of seeding content from an end user of a client device and transmitting data indicative of the selected one of the presented pair of items of seeding content to a customized content sequence generation system. The operations may further include receiving a generated customized sequence of content from the customized content sequence generation system and presenting a first item of content of the generated customized sequence of content. The operations may still further include preventing presentation of a second item of content of the generated customized sequence of content until a feedback response is received responsive to the first item of content. The operations may also include receiving the feedback response responsive to the presented first item of content and transmitting the received feedback to the customized content sequence generation system.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview of an implementation of a system for retrieving content from several content sources, generating a customized sequence of content for an end user of a client device, and receiving feedback responsive to each served content;

FIG. 2 is a process diagram of an initial seeding process for determining initial preferences of an end user;

FIG. 3 is a process diagram for generating a customized sequence of content for an end user based on the initial preference of an end user and serving the customized sequence to a client device of the end user;

FIG. 4 is a process diagram for serving content to be consumed by an end user of a client device and generating feedback responsive to the served content;

FIG. 5 is a process diagram for receiving feedback responsive to content served to several end users, generating an appeal score for the content based on the received feedback, and generating an updated customized sequence of content for each of the several end users;

FIG. 6 is a visual depiction of content separated into clusters;

FIG. 7 is an implementation of a login interface for accessing a service to select and serve a customized sequence of content for an end user;

FIG. 8 is an implementation of a seeding interface for an initial seeding process to determine initial preferences for an end user;

FIG. 9 is an implementation of a content delivery interface for serving content of the customized sequence of content to the end user and including feedback selection features for an end user to provide feedback during consumption of the content;

FIG. 10 is an implementation of an end feedback interface including feedback selection features for an end user to provide feedback after consumption of the content;

FIG. 11 is a block diagram depicting a general architecture for a computer system that may be employed to implement various elements of the systems and methods described and illustrated herein.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for providing a customized sequence of content to the end user. The various concepts introduced above and discussed in greater detail below may be implemented in any of numerous ways as the described concepts are not limited to any particular manner of implementation. Specific implementations and applications are provided primarily for illustrative purposes.

I. Overview

Implementations described herein relate to systems and methods for evaluating and retrieving content from several sources and intelligently selecting and serving the content to an end user. The selection and serving of the content to the end user may utilize an initial seeding process to determine initial preferences for the end user for generating a customized sequence of content to be presented to the user. As the end user consumes the content, the end user can provide feedback indicative of the end user's preference for the content and/or the relevance of the content to the end user. As additional content is served to the user, the corpus of feedback and previously served content may be used to update and/or modify the determined initial preferences such that future selected and served content may more accurately reflect the contemporaneous preferences of the end user.

The viewership shift from push, such as traditional television, to pull, such as web content, resulting from the spread of the Internet is sometimes reaching the other end of the scale. Web content is so widely available that end users are often lost in the ocean of content which may be good or bad, relevant or not, based on the end user's preference or random, etc.

In that context, it may be useful to provide a hassle-free experience that provides content tailored to the specific end user. End users create their own laid-back, easy experience for experiencing content by providing feedback to content and/or through an initial seeding process. For instance, each end user may respond to various seeding queries to generate an initial profile of initial preferences and/or may freely select the categories for content of interest to the end user. Direct feedback by an end user can produce the best content for the specific end user, especially as user preferences may dynamically change over time. The dynamic relevance of each piece of content consumed by an end user influences the future content presented to that end user. In some implementations, indirect feedback may be provided through actions or inactions of the end user relative to the item of content. Thus, in some implementations, direct feedback from the end user may not be needed.

End users provide feedback during or after interacting with each piece of content. In some instances, feedback data created by an end user may develop relevant user group assignment based on the feedback data. Feedback may be calculated and correlated with any of other feedback by the specific end user, a user group to which the end user is associated, feedback of other end users without regard to group membership, etc. In some instances, providing feedback produces the effect of pressing a “next” button. Without providing feedback, the end user may be prevented from viewing or moving on to the next piece of content in a sequence. A backend system may dynamically calculate what content should be presented to the end user based on that end user's feedback to previously served content and/or the feedback of similar end users on the same content and/or similar content.

In some implementations, advertisements and/or other third-party content, such as commercials and other forms of advertisement, can be displayed based on statistical analysis of feedback by an end user. In some implementations, the advertisements and/or other third-party content may be presented to end users based on targeting selection criteria for an advertiser or third-party content provider and based on a profile and/or preferences of the end user.

Some implementations may utilize a client-server model to select and content to one or more client devices, such as through an interface of a webpage, an interface of an application executing on the client device, etc. In some implementations, a backend system can collect content from different sources and/or collect links to content from different sources and transmit the set of collected content and/or links to the content to an end user's client device, such as “smart” devices including televisions, set top boxes, smartphones, tablets, etc., or the backend system can make the content available to an end user via an interface that is accessible over a network, such as the Internet. The set of collected content and/or links to content is based on an initially seeded profile associated with the end user and/or based on feedback regarding previously selected and served content. Thus, the system may provide an intelligent content-serving service by evaluating content, such as videos, articles, documents, images, etc., from different sources and generating a sequence of the content or links to the content so that an end user can consume a customized set of relevant created content.

In some implementations, the actions required to be performed by the end user may be limited. For instance, to generate the set of content and/or links to content for an end user, the end user may simply need to respond to a feedback/evaluation mechanism at the end of each served content by indicating whether the end user liked the served content or not. Based on the end user's feedback, a profile and/or preferences may be generated. As more content is consumed, the profile and/or preferences may be updated to refine the selection of content for the end user. Thus, more relevant content may be selected to be included in the sequence for each end user based on the profile and/or preferences.

In some implementations, the end user is presented with a tailor made playlist of content (e.g., video, articles, documents, photos etc.) based on an initial analysis or seeding of the end user's profile and the ongoing feedback of whether the end user likes or dislikes each specific item of content served by the service. The feedback from the end user may be received via different methods, apparatus, and mechanisms, such as up and/or down voting buttons, left and/or right swiping, numerical rating, etc. The feedback can be binary (i.e., 0 for negative, 1 for positive), graduated into several levels (e.g., scored from 0 to 5 in increments of 1, scored from 0 to 10, scored from −5 to 5, scored from −10 to 10, etc.), continuous, etc.

In some implementations, the end user may be required to give feedback for each content item presented to the end user (i.e., the end user cannot proceed to viewing the next content without providing feedback to the previous served content). In some implementations, the end user may not be required to provide feedback, but proceeding to the next content in the sequence may be made difficult without providing feedback (e.g., a small link to proceed to the next content may be provided, presentation of an advertisement or other third-party content may be provided before permitting the end user to proceed to the next content, etc.) or proceeding to the next content in the sequence without providing feedback may be made disadvantageous operationally or socially for the user to refrain from providing feedback (e.g., subsequent content may be provided in degraded quality, etc.).

In some implementations, the feedback mechanism functions also as a “next” button, (i.e., selection of a feedback feature also automatically requests, loads, and/or links to the next content of the sequence). In some implementations, advertising or other third-party content can be selected and displayed based on targeting metrics that utilize the end user's feedback, profile, and/or votes while using the service.

While the foregoing has provided an overview of providing a customized sequence of content to an end user, the following provides more details regarding various implementations.

II. Overview of System for Providing a Customized Sequence of Content

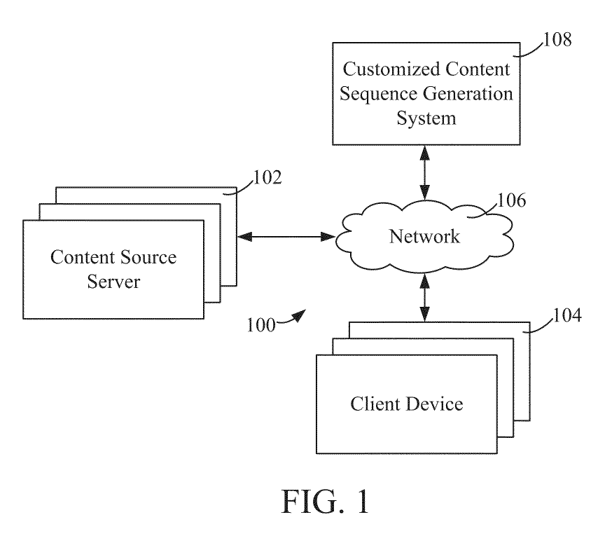

FIG. 1 is a block diagram of an implementation of a system 100 for providing information via at least one computer network such as the network 106. The network 106 may include a local area network (LAN), wide area network (WAN), a telephone network, such as the Public Switched Telephone Network (PSTN), a wireless link, an intranet, the Internet, or combinations thereof. The system 100 can also include at least one data processing system, such as a customized content sequence generation system 108. The customized content sequence generation system 108 can include at least one logic device, such as a computing device having a data processor, to communicate via the network 106, for instance with a content source server 102 and/or a client device 104. The customized content sequence generation system 108 can include one or more data processors configured to execute instructions stored in a memory device to perform one or more operations described herein. In other words, the one or more data processors and the memory device of the content item selection system 108 may form a processing module. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, C, C++, C#, Java®, JavaScript®, Perl®, HTML, XML, Python®, and Visual Basic®. The processor may process instructions and output data for a generated customized content sequence to effect presentation of content for an end user of a client device 104. In addition to the processing circuit, the customized content sequence generation system 108 may include one or more databases configured to store data, such as an end user preference database, a content source database, a content database, etc. The customized content sequence generation system 108 may also include an interface configured to receive data via the network 106 and to provide data from the customized content sequence generation system 108 to any of the other devices on the network 106. The customized content sequence generation system 108 can include a server or several servers.

The client device 104 can include one or more devices such as a computer, laptop, desktop, smart phone, tablet, personal digital assistant, set-top box for a television set, a smart television, or server device configured to communicate with other devices via the network 106. The device 104 may be any form of electronic device that includes a data processor and a memory. The memory may store machine instructions that, when executed by a processor, cause the processor to perform one or more of the operations described herein. The memory may also store data to effect presentation of content on the computing device. The processor may include a microprocessor, an application-specific integrated circuit (ASIC), a field-programmable gate array (FPGA), etc., or combinations thereof. The memory may include, but is not limited to, electronic, optical, magnetic, or any other storage or transmission device capable of providing processor with program instructions. The memory may include a floppy disk, compact disc read-only memory (CD-ROM), digital versatile disc (DVD), magnetic disk, memory chip, read-only memory (ROM), random-access memory (RAM), Electrically Erasable Programmable Read-Only Memory (EEPROM), erasable programmable read only memory (EPROM), flash memory, optical media, or any other suitable memory from which processor can read instructions. The instructions may include code from any suitable computer programming language such as, but not limited to, ActionScript®, C, C++, C#, HTML, Java®, JavaScript®, Perl®, Python®, Visual Basic®, and XML.

In some implementations, the client device 104 can execute a software application (e.g., a web browser, a specific application for retrieval and presentation of content, and/or other applications) to retrieve and/or present content from other computing devices over network 106. Such an application may be configured to retrieve content from the customized content sequence generation system 108 and/or from a content source server 102. In an implementation, the application may be a customized application executing on the client device 104 for interacting with the customized content sequence generation system 108 to retrieve a customized sequence of content for presentation on a display of the client device 104. In some implementations, the customized sequence of content may include links to content to be retrieved by the client device 104 from content source servers 102 and/or the customized sequence of content may include content retrieved from content source servers 102 by the customized content sequence generation system 108 and provided directly to the client device 104 from the customized content sequence generation system 108.

In other implementations, the client device 104 may execute a web browser application which provides a browser window on a display of the client device. The web browser application that provides the browser window may operate by receiving input of a uniform resource locator (URL), such as a web address, from an input device (e.g., a pointing device, a keyboard, a touch screen, or another form of input device). In response, one or more processors of the client device executing the instructions from the web browser application may request data from another device connected to the network 106 referred to by the URL address. The other device may then provide web page data and/or other data to the client device 104, which causes visual indicia to be displayed by the display of the client device 104. In some implementations, the retrieved web page may include an interface for interacting with the customized content sequence generation system 108 and/or for presentation of content from one or more of the content source servers 102.

The one or more content source servers 102 can include a computing device, such as a server, configured to host content, such as videos, articles, documents, audio files, images, comment threads, music, graphics, information feeds, etc. The content source server 102 may be a computer server (e.g., a file transfer protocol (FTP) server, file sharing server, web server, etc.) or a combination of servers (e.g., a data center, a cloud computing platform, etc.). The content source server 102 can provide content to the client device 104 responsive to a request for content from the client device 104 and/or to the customized content sequence generation system 108 responsive to a request from the customized content sequence generation system 108. In one implementation, the client device 104 can access the content source server 102 via the network 106 to request data to effect presentation of content of the content source server 102 on a display of the client device 104.

III. Initial Seeding Process

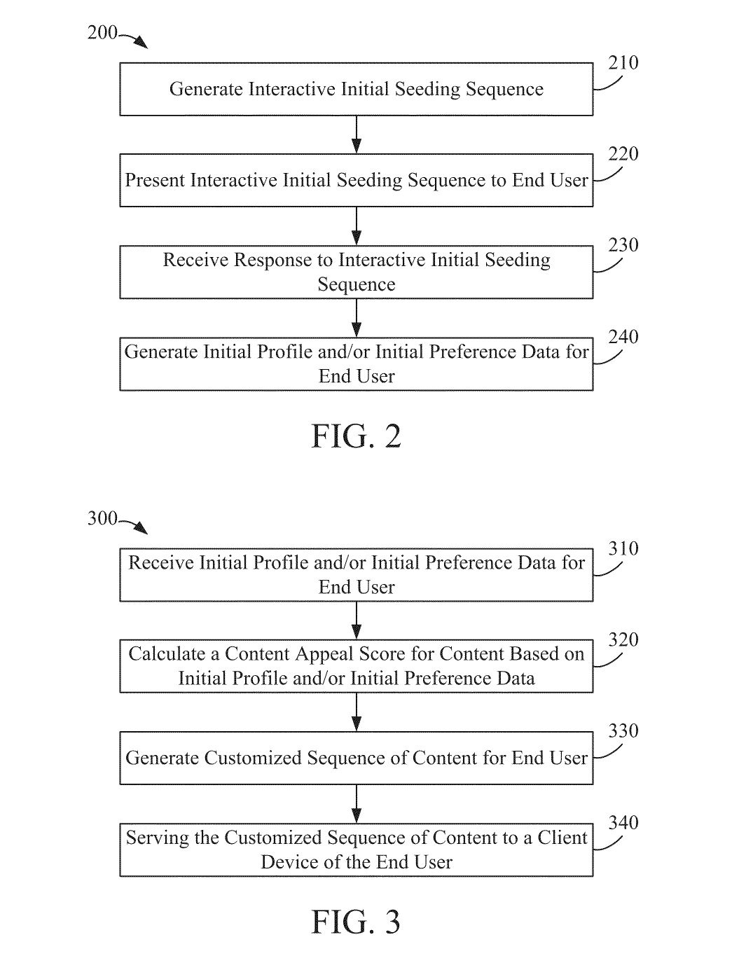

FIG. 2 is a process diagram of an initial seeding process 200 for determining initial preferences of an end user. The process 200 may be implemented by the customized content sequence generation system. The process 200 includes generating an interactive initial seeding sequence (block 210). In some implementations, the interactive initial seeding sequence may include several either/or selection options of various seeding content, such as video media, image media, audio media, documents, words, etc. For instance, the interactive initial seeding sequence may include a set of ten pairs of seeding images that an end user selects an image of each pair. In other implementations, the interactive initial seeding sequence may include several sets of pairs of seeding videos that an end user selects from. In still further implementations, a mix of seeding content may be used for the interactive initial seeding sequence, such as a pair of seeding videos, a pair of seeding images, a pair of seeding audio, a pair of seeding documents, a pair of seeding words, etc. Thus, the interactive initial seeding sequence includes several sets of seeding content that can be used for either/or selection by an end user.

In some implementations, the interactive initial seeding sequence may include more than a pair of items of seeding content, such as sets of three items of seeding content, four items of seeding content, five items of seeding content, ten items of seeding content, etc. The several items of seeding content for the interactive initial seeding sequence may be used to have the end user select one of the several items of seeding content or several items of seeding content (e.g., the end user selects two or more items of seeding content presented).

The interactive initial seeding sequence is presented to the end user (block 220) such that the end user can select from the presented seeding content. In an implementation, the interactive initial seeding sequence is transmitted from the customized content sequence generation system to a client device, such as client device 104 of FIG. 1. The interactive initial seeding sequence may be transmitted as including a series of links to seeding content to be retrieved by the client device. In other implementations, the interactive initial seeding sequence may include the seeding content. The seeding content of the interactive initial seeding sequence may be presented as a pair of seeding content displayed as part of a user interface, such as user interface 800 of FIG. 8. The presented items of content of the interactive initial seeding sequence may include a prompt along with each presented items of seeding content, such as “Which photo do you prefer?” or “Which item expresses you more?”

If more than two items of seeding content are presented for selection by the end user, the several items of seeding content may be presented in the user interface. In some instances, the end user can select several of the presented items of seeding content or may be limited to selecting only a single presented item of seeding content.

In some implementations, each item of content presented may be associated with a unique identifier such that, as the end user progresses through the interactive initial seeding sequence of seeding content, a string of unique identifiers may be generated based on the end user's selections. The string of unique identifiers may be stored and transmitted to the customized content sequence generation system at the end of the initial seeding process 200. In other implementations, each selection may result in the client device transmitting the unique identifier associated with the selected item of seeding content.

The process 200 includes receiving a response to the interactive initial seeding sequence (block 230). As noted above, in some implementations the end user selections responsive to the interactive initial seeding sequence may be a string of identifiers for the selected items of seeding content. The customized content sequence generation system may receive the string of identifiers as part of a web request, as part of an image request, and/or any other transmission.

The customized content sequence generation system generates an initial profile and/or initial preference data for the end user (block 240) based on the received response to the interactive initial seeding sequence. In some implementations, the customized content sequence generation system may utilize the response data from the interactive initial seeding sequence to cluster the end user with other end users with similar responses to the interactive initial seeding sequence. Thus, the customized content sequence generation system may utilize the feedback responses of other end users clustered with the end user responding to the interactive initial seeding sequence to generate an initial profile and/or initial preference data for the end user. Such clustering may be performed using k-means clustering, k-NN (nearest-neighbor) clustering, etc.

In other implementations, the customized content sequence generation system may associate each item of seeding content from the interactive initial seeding sequence with one or more keywords, categories for content, etc. Based on the received response to the interactive initial seeding sequence, the customized content sequence generation system may generate a set of data indicative of the one or more keywords, categories of content, etc. and associate the generated set of data with an identifier for the end user, such as a login username, a unique identifier for the end user, an account of the end user, etc.

In some implementations, the generation of the initial profile and/or preference data may include matching the responses to the interactive initial seeding sequence to one or more pre-determined initial profiles. For instance, for an interactive initial seeding sequence of ten pairs of items of seeding content to be selected by an end user, there are 1,024 different permutations. Thus, each possible permutation of the responses to the interactive initial seeding sequence may be associated with a pre-determined initial profile and/or preference data. In other implementations, the response to the interactive initial seeding sequence may be used as input into a model to generate the initial profile and/or preference data.

In some implementations, each response to items of seeding content of the interactive initial seeding sequence may be transmitted to the customized content sequence generation system to retrieve a subsequent set of items of seeding content for the interactive initial seeding sequence. Thus, the interactive initial seeding sequence may vary responsive to each response to the items of seeding content of the interactive initial seeding sequence. Accordingly, the interactive initial seeding sequence may be different for each end user based on the provided responses.

In some implementations, the generation of the initial profile and/or initial preference data may be independent of receiving responses to an initial seeding sequence. For instance, a new user may have data associated with the user indicative of characteristics of the user, such as demographic information, location information, etc. Based on this associated information, the user may be clustered with other end users and an initial profile and/or initial preference data may be populated using the profile and/or preference data for the other end users. The demographic information, location information, or other information may be received responsive to the user providing the information (e.g., via a sign-up form, etc.), may be received passively, such as detection of location via IP address, or may be received from a third-party (e.g., via Facebook® profile data, etc.).

IV. Generation of Customized Sequence of Content

FIG. 3 is a process diagram for generating a customized sequence of content for an end user based on the initial preference of an end user and serving the customized sequence to a client device of the end user. The process 300 may be implemented by the customized content sequence generation system. The process 300 includes receiving an initial profile and/or initial preference data for an end user (block 310). In some instances, the initial profile and/or initial preference data may be received as a result of the initial seeding process 200 of FIG. 2. In other instances, the initial profile and/or initial preference data may be received from another party, such as a third-party data provider. In still further instances, the initial profile and/or initial preference data may be specified by an end user, such as selection of one or more keywords, categories, etc. that the end user selects to generate an initial profile and/or initial preference data.

The process 300 further includes calculating a content appeal score for content based on the initial profile and/or initial preference data (block 320). The calculation of a content appeal score may include receiving content data for an item of content from a content source, such as a content source server 102. The content data may include a source identifier for the content source, a content identifier, and content characteristics, such as a length of time for video or audio content, one or more keywords associated with the subject matter of the content, a category for the content, a type of the content, a likeability of the content (e.g., as indicated by a total number of views, a number of views per time period, such as per hour, day, week, month, year, etc.), an age of the content, etc.

The calculation of content appeal may also include receiving other end user data relative to the content data. The other end user data may be all of the other end user data for the item of content for which a content appeal score is to be calculated or a subset of end user data for the item of content, such as for other end users with which the current end user is clustered and/or other end users in a group with the current end user. The other end user data may include behavioral data, preference data, demographic data, location data, etc. The behavioral data may include data such as an amount of time the other end user viewed the content, a percentage of a total time the other end user viewed the content, etc. The preference data may include feedback response data indicative of whether the other end users likes or dislikes the content or similar content. The demographic data may include demographics for the other end users, such as a gender, an age or age grouping, an education level or education level grouping, etc. The location data may include a specific location, a city-level location, a state or province level location, a region-level location, a country-level location, a continent-level location, etc.

The calculation of a content appeal score for an item of content may utilize the initial profile and/or initial preference data, the content data for the item of content, and/or the other end user data in generating the content appeal score for a current end user. In some implementations, several algorithms may be utilized to generate several different content appeal scores, where each algorithm approaches the content appeal of an item of content from a different angle from the other algorithms of the several algorithms. The several different content appeal scores may be input into an aggregating algorithm to generate an aggregate content appeal score. Such an aggregate content appeal score may be the calculated content appeal score for process 300. In some implementations, the aggregating algorithm may apply weight values the several different content appeal scores, such as static weight values or dynamic weight values. In other implementations, a single algorithm may be utilized to calculate the content appeal score (block 320).

The calculation of a content appeal score may utilize the initial profile and/or initial preference data, the content data for the item of content, and/or the other end user data to determine how likely the item of content will appeal to the end user of the initial profile and/or initial preference data. That is, the calculation of the content appeal score for an item of content may determine how closely related the end user is to other end users based on the initial profile and/or initial preference data and the other end user data and based on the received feedback of the other end users for the item of content. For instance, the end user may be clustered with other end users based on the similarity of the initial profile and/or initial preference data to the other end user data. Referring briefly to FIG. 6, a visual depiction of clustering of an end user, such as end user 1 610, relative to other end users 620, 630, 640, 650 is shown. Thus, the end user 1 610 is similar to end user 2 620 and end user 3 630 and less similar to end user 4 640 and end user 5 650. For a given item of content, the received feedback for the given item of content from the other end users may be determined and, based on the received feedback from the other end users and how similar the initial profile and/or initial preference data for the end user is to the other end user data of the other end users, a content appeal score may be calculated. Thus, the content appeal score may take into account not just the similarity of an item of content to other items of content, but also the similarity of an end user to other end users and the received feedback of those other end users for the item of content.

In some implementations, the content appeal scores for items of content may be generated using only a subset of other end users. For instance, referring still to FIG. 6, the end user 1 610 is clustered with end user 2 620 and end user 3 630. Thus, the content appeal score for an item of content may, in some implementations, utilize the other end user data for end user 2 620 and end user 3 630 and the feedback for the item of content provided by end user 2 620 and end user 3 630 to determine the content appeal score while omitting the other end user data for end user 4 640 and end user 5 650 and the feedback for the item of content provided by end user 4 640 and end user 5 650. Thus, the content appeal scores for items of content may be quickly determined by only using a subset or sub-cluster of other end users.

Referring back to FIG. 3, the process 300 further includes generating a customized sequence of content for the end user (block 330). A set of content appeal scores for several items of content may be ranked and the customized sequence of content may be generated based on the ranked set of content appeal scores. For instance, the top ten content appeal scores may be utilized to generate the customized sequence of content. In other implementations, a top fifteen, a top twenty, a top fifty, a top one hundred, etc. may be used to generate the customized sequence of content. The customized sequence of content may simply be a set of references (e.g., links and/or content identifiers) to the content associated with each of the content appeal scores. In other instances, the customized sequence of content may include the rank and/or content appeal score with the set of references. In still other implementations, the customized sequence of content may include the data to present each item of content of the customized sequence of content. For instance, the customized sequence of content may include one or more image files, video files, audio files, documents, etc.

The process 300 includes serving the customized sequence of content to a client device of the end user (block 340). The serving of the customized sequence of content may include transmitting the set of references of the customized sequence of content to a client device of an end user responsive to a request for a customized sequence of content. In other implementations, the serving of the customized sequence of content may include transmitting the set of references and the corresponding ranking and/or content appeal score for each item of content of the customized sequence of content to the client device of an end user responsive to a request for a customized sequence of content. In still other implementations, the serving of the customized sequence of content may include transmitting data to effect presentation of each item of content of the customized sequence of content to a client device of an end user responsive to a request for a customized sequence of content.

In some implementations, the customized sequence of content may be served to a third-party, such as a content source and/or other third-party, for providing customized sequences of content to end users using the customized content sequence generation system. For instance, the customized content sequence generation system 108 may receive items of content for the third-party and/or end user data and generate customized content sequences of content for the end users to consume. Thus, the customized content sequence generation system may only need to receive end user data and/or items of content from the third-party and may output the customized sequences of content for the third-party. Such a system may generate customized sequences of content, such as videos, documents, pictures, etc. for a third-party. The generating of the customized sequence of content may be performed in accordance with process 300 of FIG. 3 in some implementations.

V. Serving Customized Sequence of Content and Receiving Feedback

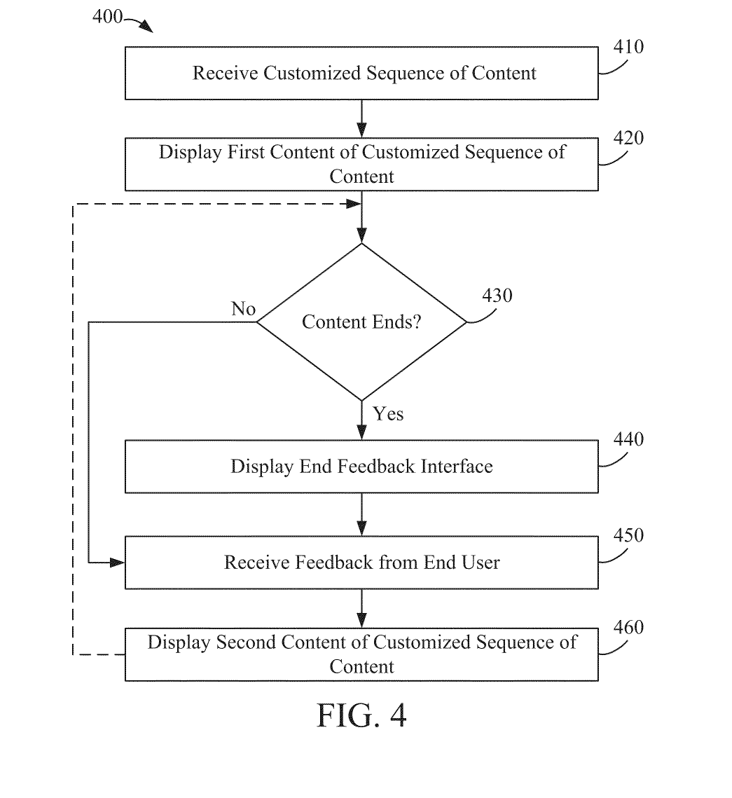

FIG. 4 is a process diagram for serving content to be consumed by an end user of a client device and generating feedback responsive to the served content. The process 400 may be implemented by a client device of an end user interacting with the customized content sequence generation system. The process 400 includes receiving a customized sequence of content (block 410). The receiving of the customized sequence of content may include receiving, via a network, a set of references of the customized sequence of content responsive to a request for a customized sequence of content. In other implementations, the receiving of the customized sequence of content may include receiving the set of references and the corresponding ranking and/or content appeal score for each item of content of the customized sequence of content. In still other implementations, the receiving of the customized sequence of content may include receiving data to effect presentation of each item of content of the customized sequence of content.

In some implementations, the receiving of the customized sequence of content may be via an application executing on the client device of an end user. In other implementations, the receiving of the customized sequence of content may be via an interface through a web page loaded through a web browser on the client device.

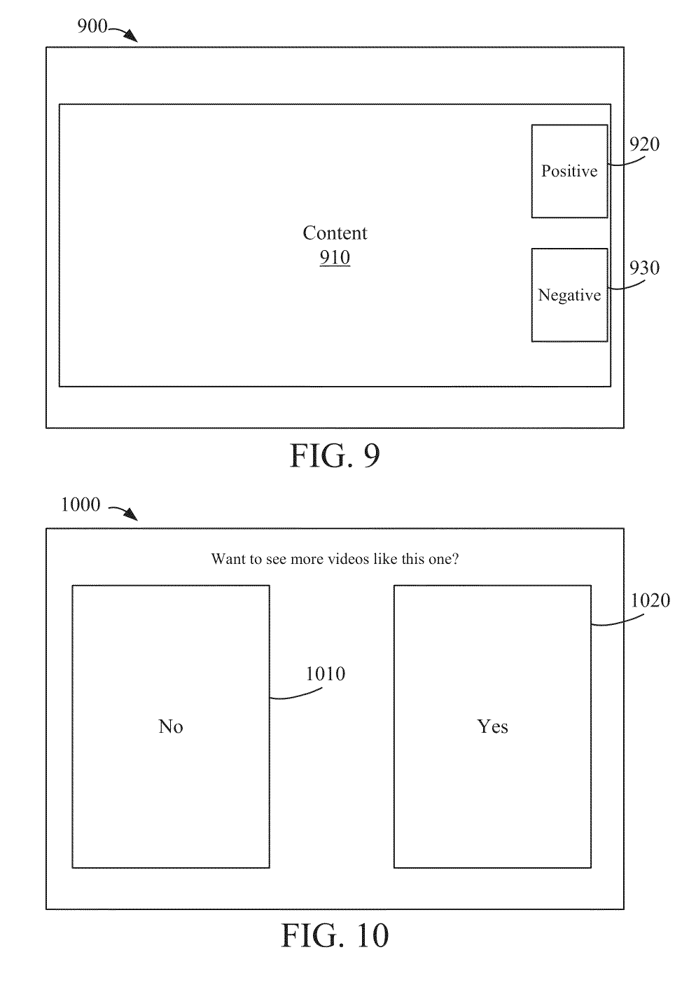

The process 400 includes displaying a first content of the customized sequence of content (block 420). In some implementations, the received customized sequence of content may include a reference to the first content, such as a link or other reference to the first content. The client device may automatically retrieve the first content of the customized sequence of content responsive to receiving the customized sequence of content. For instance, an application executing on the client device may include instructions to automatically retrieve the first content identified by a first reference of the customized sequence of content. The client device may then present the first content via the client device, such as displaying an image or video, playing back an audio file, opening a document, etc. In other implementations, the received customized sequence of content may include the data for the first content, such as an image file, a video file, an audio file, a document file, etc. The client device may then present the first content via the client device, such as displaying an image or video, playing back an audio file, opening a document, etc. The content may be presented via a user interface, such as user interface 900 of FIG. 9.

In some implementations, the process 400 may determine whether the content has ended (block 430). For instance, a user interface when presenting the content may include one or more feedback selection features, such as feedback selection features 920, 930 of user interface 900 when presenting content 910 of FIG. 9. In some implementations, the selection of a feedback selection feature, such as a negative feedback feature, may automatically stop the presentation of the content. In other implementations, the selection of a feedback selection feature, such as a positive feedback feature, may permit the content to continue to be presented to the end user until the end of the content (e.g., until the end of a video, until an end of an audio file, until the final page of a document, etc.).

If the content has ended (block 430) and no feedback has been received, then the process 400 may display an end feedback interface (block 440). The end feedback interface may prevent an end user from proceeding to presentation of a second content item unless feedback is provided. Thus, the process 400 may require each end user to provide feedback for each content item consumed. That is, at the end of the each item of content (e.g., each video, image, article, audio, etc.) if the end user has not provided feedback, then a feedback mechanism, such as the end feedback interface having modal dialog, intercedes and presentation of subsequent content is prevented unless the end user casts feedback. In other implementations, the feedback interface may delay an end user from continuing to the second content, such as through a timer, or through an obscured link. In some implementations, the end feedback interface may be end feedback interface 1000 of FIG. 10.

The process 400 may further include receiving feedback from an end user responsive to the first content presented to the end user (block 450). In some implementations, the received feedback may occur during the presentation of the first content (block 430). In some instances, the received feedback may automatically terminate the presentation of the first content, such as responsive to receiving negative feedback. In other instances, the received feedback may permit the first content to be continued to be presented, but will not prevent the end user from proceeding to the second content once the presentation of the first content is concluded. In some implementations, the received feedback may be binary (i.e., 0 for negative, 1 for positive), graduated into several levels (e.g., scored from 0 to 5 in increments of 1, scored from 0 to 10, scored from −5 to 5, scored from −10 to 10, etc.), continuous, etc. The received feedback may be stored in a feedback response data structure that logs the received feedback to each presented content item. Such a feedback response data structure may be transmitted to the customized content sequence generation system at a later time, such as responsive to an end user's action (e.g., logging out of an application or service, after consuming a predetermined number of items of content, etc.) or periodically (e.g., hourly, daily, weekly, monthly, yearly, etc.). In other implementations, the received feedback may be transmitted from the client device to the customized content sequence generation system when the feedback response is received by the client device. For instance, when an end user viewing content selects a feedback feature, a feedback data structure may automatically be generated and transmitted to the customized content sequence generation system.

The feedback data structure may include a content identifier associated with the content for which feedback is received, an end user identifier associated with the client device and/or an account of the end user, an interaction identifier, content data, and/or behavioral data based on how the end user interacted with the presented content.

Once feedback is received, the process 400 includes displaying a second content of the customized sequence of content (block 460). The process 400 may repeat displaying content from the customized sequence of content and receiving feedback from the end user until the end user stops consuming content, such as by closing an application executing on the client device, logging out of a service, closing a browser window displaying an interface, turning off the client device, etc.

In some implementations, the providing of feedback by the end user may be automated without needing feedback features. For instance, based on monitored behavior of the end user, a feedback response may be automatically generated. The monitored behavior may include an amount of time the end user consumes the content, a percentage of the total time for the content that the end user consumes the content, whether the end user skips through the end content, etc.

In further implementations, the items of content of the customized sequence of content may be presented together for the end user to select an item of content to view. For instance, a list, grid, and/or matrix of items of content may be presented such that the end user can select an item of content to be presented. In some implementations, the behavioral data may include which selections of content out of the list, grid, and/or matrix of items of content may be included in the behavioral data. The selections of content may include monitoring of which items of content are clicked on or not clicked on. The behavioral data may include an amount of time an end user spends viewing the list, grid, and/or matrix of items of content prior to moving to a subsequent list, grid, and/or matrix of items of content.

In some implementations, the items of content of the customized sequence of content may be selectable to be added to a watch list. For instance, a watch list selection feature may be associated with each item of content in a list, grid, and/or matrix that, when selected by the end user, adds the item of content to a watch list instead of presenting the content to the end user. In such implementations, the behavioral data may include which items of content an end user selected to be added to the watch list and which items of content were not added to the watch list.

In still further implementations, the content of the customized sequence of content may be grouped into categories of content. In some implementations, an end user may be presented with selectable categories or channels in an interface such that the end user may view different sets of items of content from the customized sequence of content based on a selected category or channel. The behavioral data may include which specific category or channel an item of content was viewed from compared to the other categories or channels presented.

VI. Updating Customized Sequence of Content Based on Received Feedback

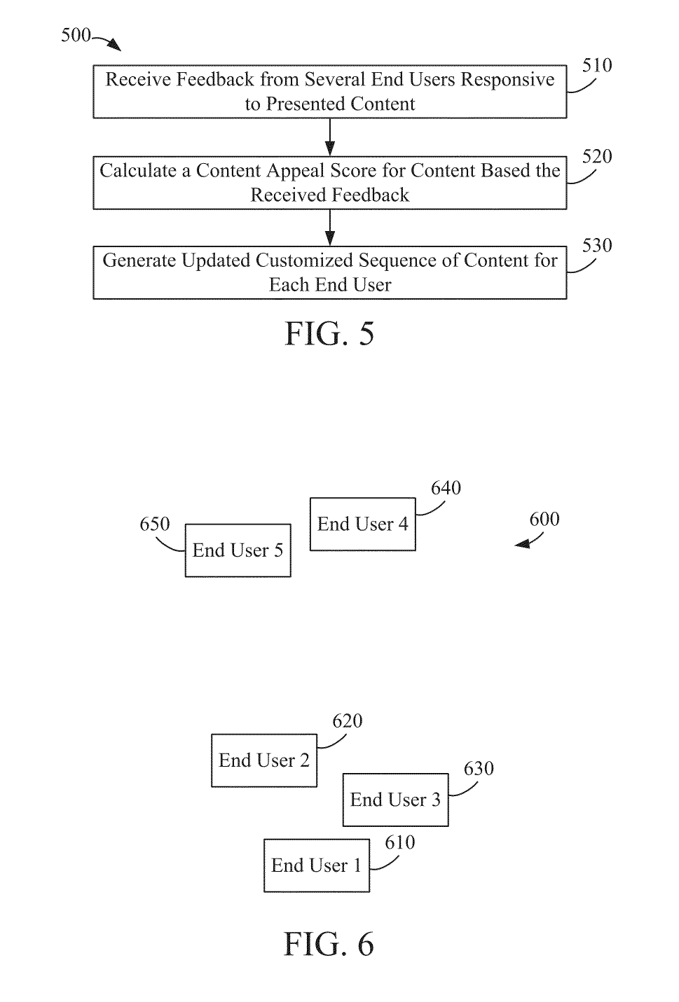

FIG. 5 is a process diagram for a process 500 for receiving feedback responsive to content served to several end users, generating an appeal score for the content based on the received feedback, and generating an updated customized sequence of content for each of the several end users. The process 500 may be implemented by the customized content sequence generation system. The process 500 includes receiving feedback from several end users responsive to presented content (block 510). The received feedback may be stored in a feedback response data structure that logs the received feedback to each presented content item for each client device of each of the several end users. The feedback response data structure may be transmitted responsive to an end user's action (e.g., logging out of an application or service, after consuming a predetermined number of items of content, etc.) or periodically (e.g., hourly, daily, weekly, monthly, yearly, etc.). In other implementations, the received feedback may be transmitted from each client device to the customized content sequence generation system when the feedback response is received by each client device. The feedback data structure may include a content identifier associated with the content for which feedback is received, an end user identifier associated with each client device and/or an account of each end user, an interaction identifier, content data, and/or behavioral data based on how each end user interacted with the presented content. In some implementations, the received feedback from several end users responsive to presented content may be stored in a database, such as a feedback database of the customized content sequence generation system. In some instances, the received feedback may be organized in the database based on the interaction identifier.

The process 500 further includes calculating a content appeal score for each item of content based on the received feedback from the several end users (block 520). The calculation of a content appeal score for an item of content may utilize the initial profile and/or initial preference data of each end user, the content data for each item of content, and/or other end user data in generating the content appeal score. In some implementations, several algorithms may be utilized to generate several different content appeal scores, where each algorithm approaches the content appeal of an item of content from a different angle from the other algorithms of the several algorithms. The several different content appeal scores may be input into an aggregating algorithm to generate an aggregate content appeal score. In some implementations, the aggregating algorithm may apply weight values the several different content appeal scores, such as static weight values or dynamic weight values. In other implementations, a single algorithm may be utilized to generate a single content appeal score.

As the end user provides feedback for items of content, the clustering of the end user with other end users may be based on the received feedback for items of content for the end user relative to the received feedback for items of content for the other end users. The calculation of the content appeal score may then utilize the similarity of other end users that provided positive feedback for an item of content to the profile and/or preference data of the end user to determine the likelihood that the end user will also provide positive feedback for the item of content. The calculation of the content appeal score may also utilize the similarity of other end users that provided negative feedback for an item of content to the profile and/or preference data of the end user to determine the likelihood that the end user will also provide negative feedback for the item of content. The calculation of the content appeal score may utilize additional weightings or algorithms to determine the final content appeal score from the positive feedback likelihood and the negative feedback likelihood. Content appeal scores may be calculated for each item of content for each end user. In some implementations, the content appeal scores for items of content may be calculated only using a subset of other end users.

In some implementations, the received feedback from the several end users may be used to update profile and/or preference data of each end user separately from calculating the content appeal score for each item of content. That is, the received feedback may utilize algorithms to modify and/or update profile and/or preference data for each end user based on the end user's feedback and the feedback from other end users. Thus, a customized content sequence generation system may maintain and update profile and/or preference data for each end user based on the end user's interactions with the presented content. Such profile and/or preference data may be utilized for other purposes than generating customized sequences of content for the end user. For instance, in some implementations, the profile and/or preference data may be utilized to target advertisements for the end user for an advertisement server, recommend products and/or services for the end user, tailor educational materials for the end user, suggest events the end user may be interested in, etc.

Based on the calculated content appeal scores for each item of content, an updated customized sequence of content for each end user may be generated (block 530). A set of content appeal scores for several items of content for each end user may be ranked and an updated customized sequence of content may be generated based on the updated ranked set of content appeal scores. For instance, the top ten content appeal scores may be utilized to generate the customized sequence of content. In other implementations, a top fifteen, a top twenty, a top fifty, a top one hundred, etc. may be used to generate the customized sequence of content. The updated customized sequence of content may simply be a set of references (e.g., links and/or content identifiers) to the content associated with each of the content appeal scores. In other instances, the customized sequence of content may include the rank and/or content appeal score with the set of references. In still other implementations, the customized sequence of content may include the data to present each item of content of the customized sequence of content. For instance, the customized sequence of content may include one or more image files, video files, audio files, documents, etc.

In some implementations, the updated customized sequence of content may be generated for each of the end users responsive to the end user performing an action, such as logging into a service, executing an application on a client device, loading an interface via a web browser, etc. Thus, the updated customized sequence of content may be updated for each user to generate a customized sequence of content to be consumed each time an end user performs the action. Thus, customized content can be delivered to each end user based on the provided feedback from the end user, behavioral data associated with the end user, feedback from other end users for other content, behavioral data for the other end users, etc.

VII. Example Interfaces and Devices

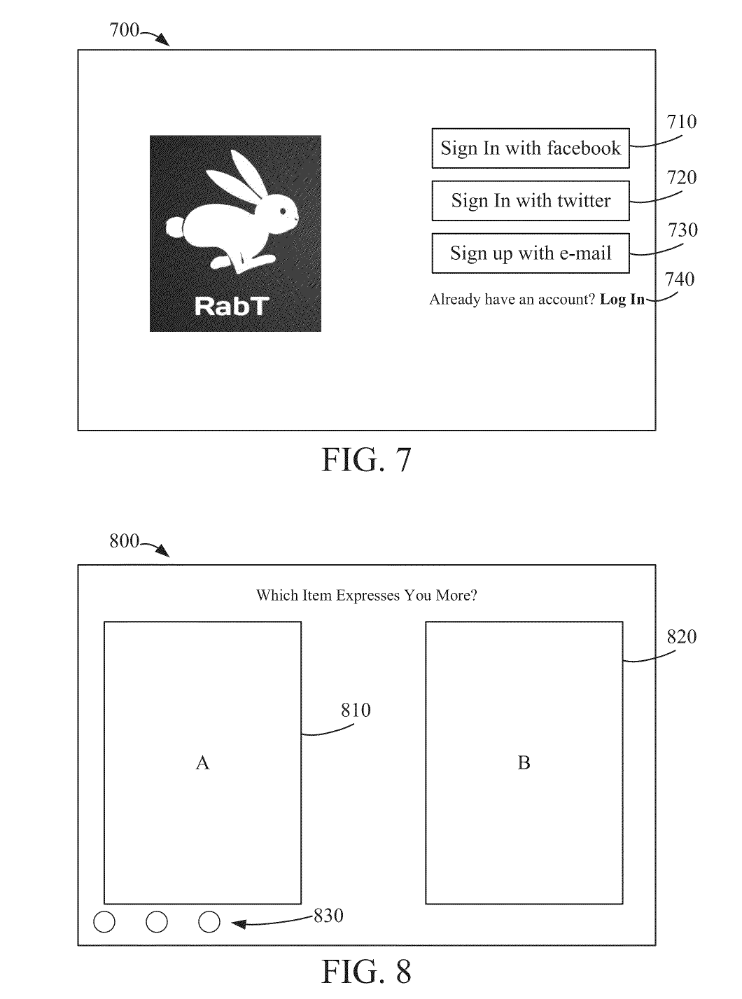

FIG. 7 is an implementation of a login interface 700 for accessing a service to select and serve a customized sequence of content for an end user. The login interface 700 may include one or more selectable features 710, 720, 730, 740 for initiating a login process. Social media selectable features 710, 720 may be associated with a corresponding social media service, such as Facebook®, Twitter®, etc. Selection of the social media selectable features 710, 720 may open a modal window for logging into the corresponding social media service using login credentials for the social media service. In some implementations, selection of the social media selectable features 710, 720 may request data from the corresponding social media service associated with the end user. The requested data may, in some instances, be used to generate an initial profile and/or initial preference data for the end user. Such requested data may be in addition to or in lieu of the generation of the initial profile and/or initial preference data via process 200 of FIG. 2.

The login interface 700 further includes a sign-up selectable feature 730 for initiating a sign-up process using an e-mail address of the end user. The login interface 700 further includes a login selectable feature 740 for initiating a login process for existing users, such as by popping up a modal window for the end user to enter a username and password.

The login interface 700 may be provided as an interface for an application executing on a client device and/or as an interface for a web-based service provided through a webpage retrieved using a web browser of a client device.

FIG. 8 is an implementation of a seeding interface 800 for an initial seeding process to determine initial preferences for an end user. In some implementations, seeding interface 800 may be utilized to present the interactive initial seeding sequence of process 200 of FIG. 2. The seeding interface 800 includes selectable content features 810, 820 for selecting content of the interactive initial seeding sequence. The presented items of content of the interactive initial seeding sequence for the selectable content features 810, 820 may include a prompt along with each presented items of content, such as “Which photo do you prefer?” or “Which item expresses you more?” In some implementations, the content presented may include videos, images, audio, documents, etc. The seeding interface 800 may further include a progress indicator 830 to indicate to an end user the progress through the initial seeding sequence. The seeding interface 800 may be provided as an interface for an application executing on a client device and/or as an interface for a web-based service provided through a webpage retrieved using a web browser of a client device.

FIG. 9 is an implementation of a content delivery interface 900 for serving content 910 of a customized sequence of content to an end user and including feedback selection features 920, 930 for an end user to provide feedback during consumption of the content 910. The content 910 presented in the content delivery interface 900 may be presented in an iframe such that the content 910 is displayed from the content source hosting the content. The feedback selection features 920, 930 may be overlaid over a portion of the content 910 or may be separate from the presented content 910. The feedback selection features 920, 930 may include binary feedback selection features (i.e., 0 for negative, 1 for positive) having a positive feedback selection feature 920 and a negative feedback selection feature 930. In other implementations, other feedback selection features may be provided, such as graduated feedback selection features separated into several levels (e.g., scored from 0 to 5 in increments of 1, scored from 0 to 10, scored from −5 to 5, scored from −10 to 10, etc.), a continuous feedback selection feature (e.g., a slide bar for providing a rating), etc. The content delivery interface 900 may be provided as an interface for an application executing on a client device and/or as an interface for a web-based service provided through a webpage retrieved using a web browser of a client device.

FIG. 10 is an implementation of an end feedback interface 1000 including feedback selection features 1010, 1020 for an end user to provide feedback after consumption of content. As discussed above, the end feedback interface 1000 may be presented after content presented to the user ends (e.g., the end of a video, the end of audio, end of a document, etc.). In other instances, the end feedback interface 1000 may be presented after a predetermined period of time (e.g., for image content, the end feedback interface 1000 may be presented after 30 seconds, 60 seconds, 5 minutes, etc.). The feedback selection features 1010, 1020 may include binary feedback selection features (i.e., 0 for negative, 1 for positive) having a positive feedback selection feature 1020 and a negative feedback selection feature 1010. In other implementations, other feedback selection features may be provided, such as graduated feedback selection features separated into several levels (e.g., scored from 0 to 5 in increments of 1, scored from 0 to 10, scored from −5 to 5, scored from −10 to 10, etc.), a continuous feedback selection feature (e.g., a slide bar for providing a rating), etc. The end feedback interface 1000 may be provided as an interface for an application executing on a client device and/or as an interface for a web-based service provided through a webpage retrieved using a web browser of a client device.

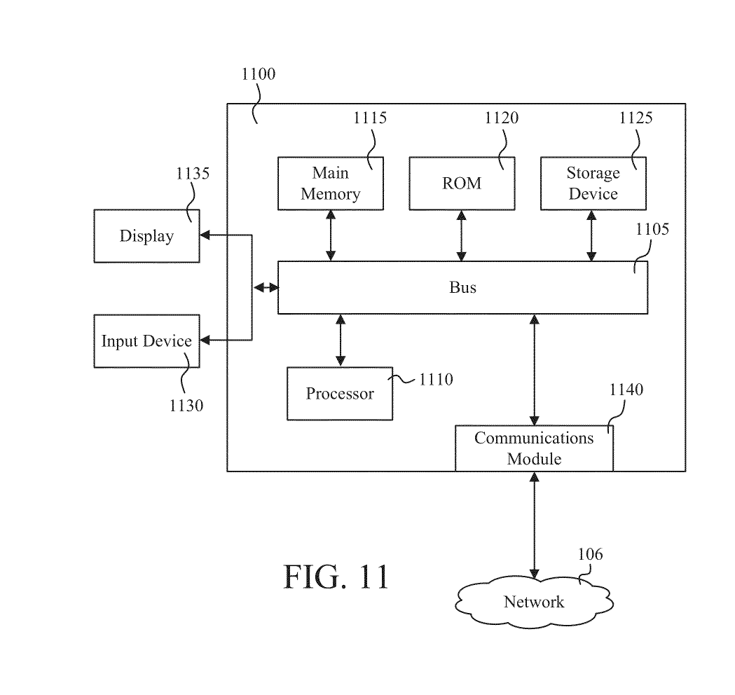

FIG. 11 is a block diagram of a computer system 1100 that can be used to implement the customized content sequence generation system 108, the client device 104, the content source server 102, and/or any other computing device described herein. The computing system 1100 includes a bus 1105 or other communication component for communicating information and a processor 1110 or processing module coupled to the bus 1105 for processing information. The computing system 1100 also includes main memory 1115, such as a RAM or other dynamic storage device, coupled to the bus 1105 for storing information, and instructions to be executed by the processor 1110. Main memory 1115 can also be used for storing position information, temporary variables, or other intermediate information during execution of instructions by the processor 1110. The computing system 1100 may further include a ROM 1120 or other static storage device coupled to the bus 1105 for storing static information and instructions for the processor 1110. A storage device 1125, such as a solid state device, magnetic disk or optical disk, is coupled to the bus 1105 for persistently storing information and instructions. Computing device 1100 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 1100 may be coupled via the bus 1105 to a display 1135, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 1130, such as a keyboard including alphanumeric and other keys, may be coupled to the bus 1105 for communicating information and command selections to the processor 1110. In another implementation, the input device 1130 may be integrated with the display 1135, such as in a touch screen display. The input device 1130 can include a cursor control, such as a mouse, a trackball, or cursor direction keys, for communicating direction information and command selections to the processor 1110 and for controlling cursor movement on the display 1135.

According to various implementations, the processes and/or methods described herein can be implemented by the computing system 1100 in response to the processor 1110 executing an arrangement of instructions contained in main memory 1115. Such instructions can be read into main memory 1115 from another computer-readable medium, such as the storage device 1125. Execution of the arrangement of instructions contained in main memory 1115 causes the computing system 1100 to perform the illustrative processes and/or method steps described herein. One or more processors in a multi-processing arrangement may also be employed to execute the instructions contained in main memory 1115. In alternative implementations, hard-wired circuitry may be used in place of or in combination with software instructions to effect illustrative implementations. Thus, implementations are not limited to any specific combination of hardware circuitry and software.

The computing system 1100 also includes a communications module 1140 that may be coupled to the bus 1105 for providing a communication link between the system 1100 and a network 1145. As such, the communications module 1140 enables the processor 1110 to communicate, wired or wirelessly, with other electronic systems coupled to the network 1145. For instance, the communications module 1140 may be coupled to an Ethernet line that connects the system 1100 to the Internet or another network 1145. In other implementations, the communications module 1140 may be coupled to an antenna (not shown) and provides functionality to transmit and receive information over a wireless communication interface with the network 1145.

In various implementations, the communications module 1140 may include one or more transceivers configured to perform data communications in accordance with one or more communications protocols such as, but not limited to, WLAN protocols (e.g., IEEE 802.11a/b/g/n/ac/ad, IEEE 802.16, IEEE 802.20, etc.), PAN protocols, Low-Rate Wireless PAN protocols (e.g., ZigBee, IEEE 802.15.4-2003), Infrared protocols, Bluetooth protocols, EMI protocols including passive or active RFID protocols, and/or the like.

The communications module 1140 may include one or more transceivers configured to communicate using different types of protocols, communication ranges, operating power requirements, RF sub-bands, information types (e.g., voice or data), use scenarios, applications, and/or the like. In various implementations, the communications module 1140 may comprise one or more transceivers configured to support communication with local devices using any number or combination of communication standards.

In various implementations, the communications module 1140 can also exchange voice and data signals with devices using any number or combination of communication standards (e.g., GSM, CDMA, TDNM, WCDMA, OFDM, GPRS, EV-DO, WiFi, WiMAX, S02.xx, UWB, LTE, satellite, etc). The techniques described herein can be used for various wireless communication networks 106 such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. A CDMA network can implement a radio technology such as Universal Terrestrial Radio Access (UTRA), cdma2000, etc. UTRA includes Wideband-CDMA (W-CDMA) and Low Chip Rate (LCR). CDMA2000 covers IS-2000, IS-95, and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2).

Although an example computing system 1100 has been described in FIG. 11, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a non-transitory tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The terms “data processing apparatus,” “computing device,” “data processor,” or “processing circuit” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular embodiments. Certain features described in this specification in the context of separate embodiments can also be implemented in combination in a single implementation. Conversely, various features described in the context of a single implementation can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method of providing content to an end user of a client device comprising:
determining, using one or more data processors, preference data for an end user responsive to feedback received from the end user;
calculating, using one or more data processors, a content appeal score for each of a plurality of items of content based, at least in part, on the preference data;
generating, using one or more data processors, a customized sequence of content for the end user based, at least in part, on the calculated content appeal scores for each of a plurality of items of content; and
serving the generated customized sequence of content to a client device of the end user responsive to a request from the client device.

2. The method of claim 1, wherein calculating the content appeal score for each of the plurality of items of content is further based on content data for each of the plurality of items of content and other end user data, wherein the other end user data comprises received feedback from each of the other end users to one or more items of content.

3. The method of claim 1 further comprising:
receiving feedback from the end user responsive to a first item of content of the generated customized sequence of content; and
generating, using one or more data processors, an updated customized sequence of content for the end user based, at least in part, on the received feedback.

4. The method of claim 3 further comprising:
serving the updated generated customized sequence of content to the client device of the end user responsive to the received feedback.

5. The method of claim 1, wherein the determined preference data is initial preference data responsive to an initial seeding process comprising an interactive initial seeding sequence including a plurality of items of seeding content to be presented for selection by the end user.

6. The method of claim 5, wherein the plurality of items of seeding content comprise video content, image content, audio content, or document content.

7. The method of claim 1, wherein determining preference data for the end user comprises clustering the end user with one or more other end users responsive to the initial seeding process.

8. The method of claim 1, wherein calculating the content appeal score for each of the plurality of items of content is further based on content data for each of the plurality of items of content.

9. The method of claim 8, wherein the content data comprises a length of time, a keyword, a category, a type of content, a likeability, or an age.

10. The method of claim 1, wherein calculating the content appeal score for each of the plurality of items of content is further based on other end user data.

11. The method of claim 10, wherein the other end user data includes behavioral data, preference data, demographic data, or location data.

12. A system comprising:
one or more data processors; and a non-transitory computer-readable storage device storing instructions that, when executed by the one or more data processors, cause the one or more data processors to perform operations comprising:
receiving a generated customized sequence of content responsive to a request;
presenting a first item of content of the generated customized sequence of content;
preventing presentation of a second item of content of the generated customized sequence of content until a feedback response is received;
receiving the feedback response responsive to the presented first item of content; and
transmitting the received feedback to a customized content sequence generation system.

13. The system of claim 12, wherein presenting the first item of content further comprises presenting a feedback selection feature with the first item of content.

14. The system of claim 12, wherein the non-transitory computer-readable storage device stores instructions that cause the one or more data processors to perform operations further comprising:
displaying an end feedback interface after presenting the first item of content.

15. The system of claim 14, wherein the end feedback interface comprises modal dialog.

16. The system of claim 12, wherein the non-transitory computer-readable storage device stores instructions that cause the one or more data processors to perform operations further comprising:
storing the feedback response responsive to the presented first item of content in a feedback response data structure; and
presenting the second item of content of the generated customized sequence of content responsive to receiving the feedback response responsive to the presented first item of content.

17. The system of claim 12, wherein the first item of content and the second item of content comprise one of: video content, image content, audio content, or document content.

18. A non-transitory computer-readable storage device storing instructions that, when executed by one or more data processors, cause the one or more data processors to perform operations comprising:
receiving an interactive initial seeding sequence comprising a pair of items of seeding content;
presenting the pair of items of seeding content via a seeding interface;
receiving a selection of one of the presented pair of items of seeding content from an end user of a client device;
transmitting data indicative of the selected one of the presented pair of items of seeding content to a customized content sequence generation system;
receiving a generated customized sequence of content from the customized content sequence generation system;
presenting a first item of content of the generated customized sequence of content;
preventing presentation of a second item of content of the generated customized sequence of content until a feedback response is received responsive to the first item of content;
receiving the feedback response responsive to the presented first item of content; and
transmitting the received feedback to the customized content sequence generation system.

19. The non-transitory computer-readable storage device of claim 18, wherein the first item of content and the second item of content comprise one of: video content, image content, audio content, or document content.

20. The non-transitory computer-readable storage device of claim 18 storing instructions that cause the one or more data processors to perform operations further comprising:
displaying an end feedback interface after presenting the first item of content.
